(19) United States
(12) Patent Application Publication
(10) Pub. No.: US 2024/0177498 A1
(43) Pub. Date: May 30, 2024

(54) METHOD FOR DETECTING LANE MARKINGS

(71) Applicant: Robert Bosch GmbH, Stuttgart (DE)

(72) Inventors: Maximilian Pittner, Erlangen (DE); Alexandru Paul Condurache, Renningen (DE); Joel Janai, Leonberg (DE)

(21) Appl. No.: 18/492,961

(22) Filed: Oct. 24, 2023

(30) Foreign Application Priority Data
Nov. 24, 2022 (DE) 10 2022 212 571.1

(51) Int. Cl. G06V 20/56; B60W 60/00; G01C 21/00; G06T 7/64; G06T 17/30; G06V 10/774; G06V 10/82

(52) U.S. Cl. CPC G06V 20/588; B60W 60/001; G01C 21/3822; G01C 21/3837; G06T 7/64; G06T 17/30; G06V 10/774; G06V 10/82; B60W 2420/42; B60W 2552/53; G06T 2207/20076; G06T 2207/20081; G06T 2207/20084; G06T 2207/30256

(57) ABSTRACT

A method for training a model to detect lane markings. The method includes: providing images that are specific to a recording by at least one sensor of a vehicle, and in which the lane markings are mapped; providing ground truth data specific to a geometry of the lane markings in the provided images; training the model on the basis of the provided images and ground truth data for a three-dimensional modeling of the geometry of the lane markings based on a parameterization of a continuous curve.

### CROSS REFERENCE

The present application claims the benefit under 35 U.S.C. § 119 of German Patent Application No. DE 10 2022 212 571.1 filed on Nov. 24, 2022, which is expressly incorporated herein by reference in its entirety.

### FIELD

The present invention relates to a method for training a model for detecting lane markings, to a method for detecting lane markings, and further to a model, a computer program and a device each for this purpose.

### BACKGROUND INFORMATION

An important component of 3D lane detection via an artificial neural network is how the network represents lane instances, i.e., the lane representation. Earlier approaches such as 3D-LaneNet [1] and Gen-LaneNet [2] (references are given at the end of the description herein for convenience) used a concept called “anchors.” In this case, an anchor consists of a proposal for a straight line that extends in the direction of travel in order to represent the approximate geometry, an position specifications in the lateral and vertical directions, in order to model deviations from the straight line.

Anchor-based methods such as 3D-LaneNet and Gen-LaneNet require line and curve fitting, respectively, as a post-processing step. In this case, a continuous line model is subsequently estimated based on the discrete predicted points.

Another method called 3D-LaneNet+ [3] uses a grid-based representation in which each grid tile contains local parameters in order to describe a line segment as a straight line. Such approaches represent lanes in a discrete manner and require a post-processing step in order to obtain the desired continuous line models. For grid-based methods such as 3D-LaneNet+, a clustering method in particular is necessary as a post-processing step. This consists of a grouping method of line segments into complete line instances. Thus, even after such post-processing step, the lines still have a discrete nature (line as a string of small straight lines), which is a disadvantage of this method.

### SUMMARY

The present invention relates to a method, to a method, to a model, to a computer program, and to a device. Further features and details of the present invention will become apparent from the disclosure herein. Here, features and details which are described in connection with the (training and application) method according to the present invention also apply, of course, in connection with the model according to the present invention, the computer program product according to the present invention as well as the device according to the present invention, and vice versa in each case, such that with regard to the disclosure of individual aspects of the present invention, reference to the individual aspects of the present invention is always made reciprocally or can be so made.

In particular, according to a first aspect of the present invention, a method for training a model to detect lane markings is provided. According to an example embodiment of the present invention, the method can comprise the following steps, which can preferably be performed sequentially or in any order and/or repeatedly:
providing images that are specific to a recording by at least one sensor of a vehicle, and in which the lane markings are mapped,
providing ground truth data specific to a geometry of the lane markings in the provided images,
training the model, in particular in the form of at least one neural network, on the basis of the provided images and the provided ground truth data for a three-dimensional modeling of the geometry of the lane markings based on a parameterization of a continuous curve.

For example, the vehicle can be implemented as a motor vehicle and/or passenger vehicle and/or an at least partially autonomous driving vehicle. Thus, it is possible that a vehicle function such as an autonomous driving function and/or a driver assistance function requires the detection of the lane markings in order to control the vehicle. Accordingly, the trained model can be used in a vehicle electronic system after training and receive the images from a sensor of the vehicle. The detection is preferentially based on deep learning and can be a 3D lane detection, in particular of lane markings on the lane, aiming to recognize the 3D geometry of lanes and/or lane lines with the aid of at least one artificial neural network of individual images, wherein a learning-based approach is used.

Preferably, within the scope of the present invention, it can be provided that the model is implemented as a machine learning model comprising an artificial neural network, wherein preferentially at least two, preferably at least 10, preferably at least 20, more preferably at least 30 parameters are determined based on an output of the artificial neural network, wherein preferably the parameters indicate control points of the curve in the form of a B-spline curve. Thus, the present invention advantageously uses a continuous 3D lane representation based on B-spline functions [6, 7]. This allows the 3D geometry of the lane or the dependent geometry of the lane markings on the lane to be represented as a parameterized 3D curve. The lateral and vertical components of the curve can be described mathematically as B-spline functions that are capable of modeling various complex lane geometries. The model used for detecting the lane markings can also be referred to as 3D-SpLineNet and can be designed to directly predict the parameters for controlling the B-spline functions along with the start and end points of each line. The present invention thus differs from conventional approaches for detecting lane markings. Among the traditional approaches, there are some methods that model the surface with parametric functions such as B-splines [4, 5]. In such methods, the parameters for the control of surface shape are determined using constraints such as parallelism of the lane, but are not predicted by neural networks. For example, it is provided that the control points are determined in the lateral and vertical direction. Such control points can represent vectors of lengths. For example, the B-spline representation can use 18 B-splines of grade 3 with 15 nodes. Accordingly, this can result in 38 parameters.

Training can advantageously be performed on the basis of the provided images and the provided ground truth data by using the provided images and the ground truth data together as training data and thus as paired data sets. Accordingly, the ground truth data can have additional information about the lane markings compared with the images provided and thus serve as a reference for training and, in particular, for a cost function.

Furthermore, according to an example embodiment of the present invention, it is advantageous if the model is implemented as a machine learning model that comprises at least one artificial neural network, preferentially with a detection head, wherein the model is trained for the three-dimensional modeling of the geometry of the lane markings in that the continuous curve is generated based on an output of the artificial neural network, in particular the detection head, for representing the, in particular three-dimensional, geometry of the lane markings, wherein the continuous curve can be implemented as a three-dimensional curve. This allows the geometry of the lane markings to be modeled according to the ground truth data and the lane markings can be reliably detected.

According to an example embodiment of the present invention, a further advantage within the scope of the present invention is achievable if the three-dimensional modeling is based on the parameterization of the continuous curve by using at least one parameter (preferentially at least 10, preferably at least 20, more preferably at least 30 parameters) of a line model to generate the continuous curve, wherein the at least one parameter is defined based on the output of the artificial neural network. In other words, the three-dimensional modeling of the geometry of the lane markings can be based on the parameterization of the continuous curve by using a parametric lane representation, in particular a parametric representation of the lane markings. This makes it possible to obtain the desired output of lane instances in the desired continuous form, whereas conventional anchor-based and raster-based representations use discrete geometries, i.e., polylines (anchor-based) or concatenated straight line segments (raster-based approaches). Consequently, according to the present invention, a lane representation and/or geometry of lane markings that does not require costly post-processing steps to create a line model, as is necessary with anchor-based and grid-based methods, can be used. Instead, the model used according to the present invention, preferentially a neural network, can directly output the parameters of the line model. For this purpose, an output layer of a detection head of the neural network can be provided. In addition, discrete lane representations typically model lines at previously determined locations, such as fixed anchor points or grid cells. This fixed setting neglects the variability of the 3D geometry of the lane markings that have occurred and makes the accuracy of the line model dependent on the resolution of the grid or the number of anchor points. For example, a short line should be represented by the same number of anchor points/grid cells as a long line and the shape of a sharp curve should not be lost at a low resolution. On the other hand, parametric line representations of lane markings do not deviate from the default settings and can model complex line geometries. In particular, for learning regression, the parametric line representation of a lane marking uses the entire line shape, while the regression of anchor-based models is based on the position of the anchor points and rejects the modeling of specific sharp curves or short lines.

Moreover, anchor-based approaches cannot directly use the given ground truth that is required to train neural networks for the detection task. Instead, the ground truth is interpolated at the position of the anchor points, which leads to errors in the ground truth. In contrast, parametric models are able to use the given ground truth directly without interpolation.

According to an example embodiment of the present invention, it can optionally be possible for the model to be trained to output the at least one parameter, preferentially together with a probability value for a presence of the lane markings and/or together with a start point and end point for a calculation of the curve upon modeling. Such outputs can be used, for example, to perform detection of lane markings during operation of a vehicle, preferentially a motor vehicle, preferably a passenger vehicle. For this purpose, the images from at least one sensor such as a camera of the vehicle can be recorded repeatedly while the vehicle is moving. For example, the detected lane markings are used by a vehicle function in order to control the vehicle and/or to issue a warning to a driver, for example to keep in lane and/or to execute a lane departure warning system and/or an autonomous driving function. For example, the vehicle is controlled by the vehicle function using the lane markings in such a way that the vehicle maintains its lane. Thus, an output of the trained model for detecting lane markings can be used directly to control a machine such as a vehicle or the like. The sensor can be mounted on the front of the vehicle, for example, and aligned in the direction of travel. This makes it possible to record images of the lane in the direction of travel. For training, such images can additionally be labeled to provide three-dimensional ground truth data for the lane.

Advantageously, within the scope of the present invention, it can be provided that the images are based on the recording by the at least one sensor of the vehicle, in which the images map a lane in the direction of travel, and wherein the ground truth data specify the geometry of the lane markings on this lane, preferentially by three-dimensional coordinates. The ground truth can be present in 3D coordinates (for example, in the form of a list or sequence of points with x, y, z coordinates). On the other hand, the B-spline control points α, β can be output by the prediction of the model. For training the model, points can first be created on the curve defined by α, β. This allows 3D point sequences to be obtained as in the ground truth and compared with the ground truth. The differences or distances of the points (loss) can form the training signal, which is used to improve the α, β estimation of the model.

According to a further aspect of the present invention, a method for detecting lane markings is provided. According to an example embodiment of the present invention, the following steps, which can preferentially be carried out sequentially or in any order and/or repeatedly, can be provided :
recording images that result from a recording by at least one sensor of a vehicle, and in which the lane markings (in particular on a lane on which the vehicle is traveling) are mapped,
detecting the lane markings in the images by applying a model that is trained for three-dimensional modeling of a geometry of the lane markings based on a parameterization of a continuous curve, preferentially by a method for training according to the present invention.

Thus, the application method according to the present invention offers the same advantages as have been described with reference to the training method according to the present invention.

Moreover, it is optionally possible that the images are repeatedly recorded in order to continuously detect lane markings in a vicinity of the vehicle during a trip, wherein the following steps are further carried out:
determining lane information on the basis of an output of the applied model,
evaluating the determined lane information by a vehicle function of the vehicle, in particular an autonomous driving function,
initiating a control of the vehicle on the basis of the evaluation.

The present invention also relates to a model for detecting lane markings that has been trained by a method according to the present invention.

The present invention can also relate to a model for detecting lane markings and for three-dimensional modeling of a geometry of the lane markings based on a parameterization of a continuous curve, which comprises a detection head having an output layer, wherein the output layer is designed for outputting a plurality of parameters for detecting and generating the continuous curve, wherein the parameters comprise at least one of: a parameter indicating an existence, and/or at least one parameter indicating the geometry. In addition, further parameters can be provided, for example for start and end point, along with K_{α}+K_{β} parameters for lateral and vertical deflection. Thus, in total, K_{α}+K_{β}+3 parameters can be provided per modeled line. This model can also optionally have been trained by a method according to the present invention. In addition, the model can be protected in terms of its architecture even when untrained.

Thus, according to an example embodiment of the present invention, the output of the model can comprise a set of parameters that control the shape of the continuous parametric curves and that model the 3D geometry of the recognized lane lines. In this case, the indication of existence can comprise a probability value for the presence of the lane marking. The detection head can have a plurality of layers, wherein the last layer (output layer) is structured in such a way that curve parameters for the existence (p) and geometry (α, β, tₛ,tₑ) for M line proposals are output. (M is a parameter that describes the maximum number of expected lines).

The present invention also relates to at least one computer program, in particular a computer program product, comprising commands which, when the computer program is executed by a computer, cause the computer to carry out the method according to the present invention.

The present invention also relates to at least one device for data processing, which is configured to carry out a method according to the present invention.

For example, a data processing device which executes the computer program can be provided as the computer. The computer can have at least one processor for executing the computer program. A non-volatile data memory can also be provided, in which the computer program is stored and from which the computer program can be read by the processor for execution.

The present invention can also relate to a computer-readable storage medium which comprises the computer program according to the present invention. The storage medium is designed, for example, as a data store such as a hard drive and/or a non-volatile memory and/or a memory card. The storage medium can be integrated into the computer, for example.

Furthermore, the method according to the present invention can also be carried out as a computer-implemented method.

Further advantages, features and details of the present invention will become apparent from the following description, in which exemplary embodiments of the present invention are described in detail with reference to the figures. The features mentioned in the present disclosure can be essential to the present invention in each case individually or in any combination.

### BRIEF DESCRIPTION OF THE DRAWINGS

FIG. 1 shows a method, a device, a computer program and model according to exemplary embodiments of the present invention.

FIG. 2 shows an overview of the method according to exemplary embodiments of the present invention.

FIG. 3 shows a comparison of the anchor-based and the proposed parametric approach according to the present invention.

### DETAILED DESCRIPTION OF EXAMPLE EMBODIMENTS

In the following figures, identical reference signs are also used for the same technical features of different embodiments.

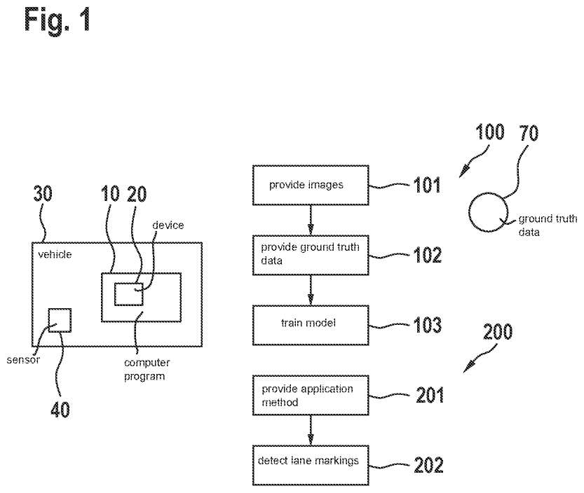

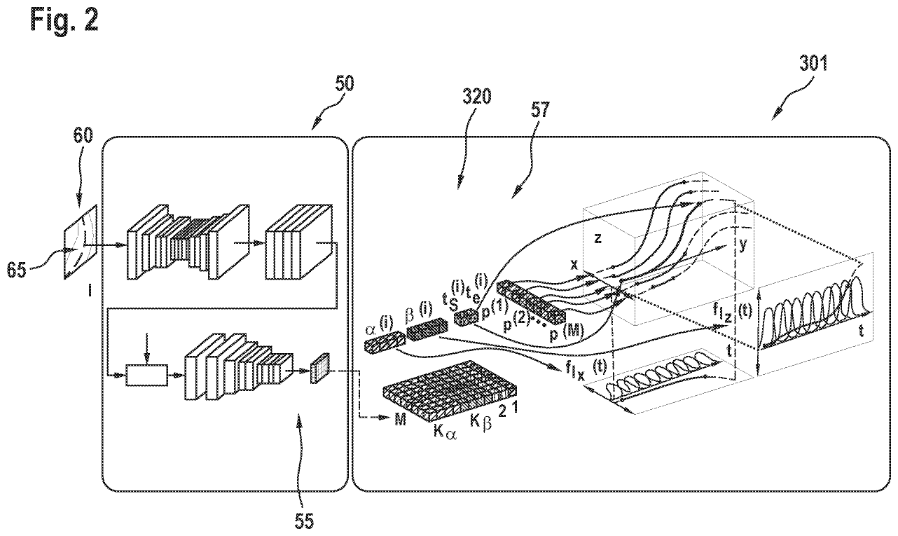

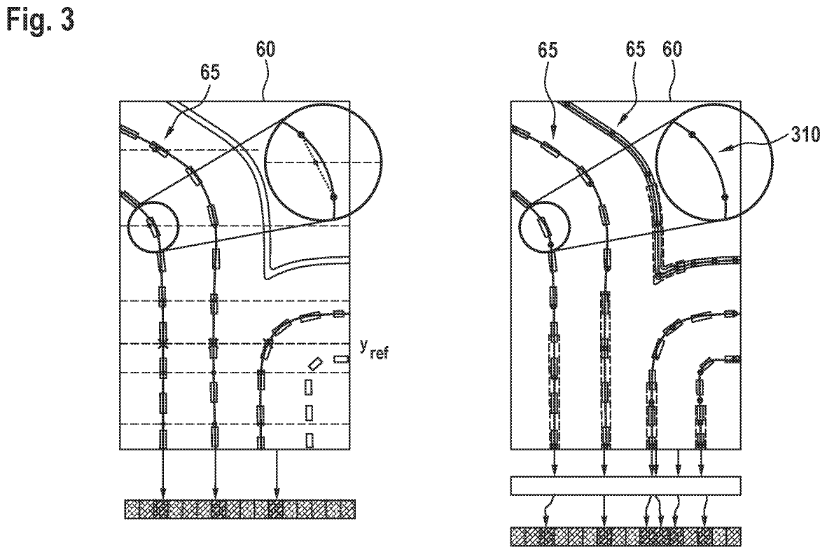

FIG. 1 schematically visualizes a method 100 according to the present invention for training a model 50 to detect lane markings 65. In this case, according to a first method step 101, images 60 (shown schematically in FIG. 2) can be provided, wherein the images 60 are specific for a recording by at least one sensor 40 of a vehicle 30, and in which the lane markings 65 (shown schematically in FIG. 3) are mapped. Subsequently, according to a second method step 102, ground truth data 70 specific to a geometry of the lane markings 65 in the provided images 60 can be provided. Then, according to a third step 103, the training of the model 50 can be carried out on the basis of the provided images 60 and ground truth data 70 for a three-dimensional modeling 301 of the geometry of the lane markings 65 based on a parameterization 320 of a continuous curve 310 (see also FIGS. 2 and 3).

The model 50 can be implemented as a machine learning model that comprises at least one artificial neural network 50, preferentially with a detection head 55. This is shown in further detail in FIG. 2. In this case, the model 50 can be trained for three-dimensional modeling 301 of the geometry of the lane markings 65 by generating the continuous curve 310 based on an output 57 of the artificial neural network 50, in particular the detection head 55, for representing the geometry, in particular the three-dimensional geometry, of the lane markings 65. The three-dimensional modeling 301 can also be thereby based on the parameterization 320 of the continuous curve 310 by using at least one parameter α, β of a line model to generate the continuous curve 310, wherein the at least one parameter α, β is defined based on the output 57 of the artificial neural network 50. The model 50 can also be trained to output the at least one parameter α, β together with a probability value p for the presence of the lane markings 65 and/or together with a start point tₛ and end point tₑ for a calculation of the curve 310 in the modeling 301.

Furthermore, an application method 200 visualized in FIG. 1 can be provided, in which a recording 201 of images 60 that results from a recording by at least one sensor 40 of a vehicle 30, and in which the lane markings 65 are mapped, and a detection 202 of the lane markings 65 in the images 60 by applying a model 50 that is trained for a three-dimensional modeling 301 of a geometry of the lane markings 65 based on a parameterization 320 of a continuous curve 310 are provided.

FIG. 1 also shows a computer program 20 and a device 10 according to embodiments of the present invention.

In FIG. 2 it is shown that the model, preferentially called 3D-SpLineNet, contains an RGB image I taken by a front-facing camera of the vehicle. As the output, the model can provide the parameters α, β,tₛ,tₑ per line to model the geometry and the region and to indicate the existence probability p for each 3D curve proposal.

The main differences between anchor-based and parametric lane representations, which illustrate the advantage of parametric models, are shown in FIG. 3. It is illustrated that, according to exemplary embodiments of the present invention, a regression is carried out over the entire line using the real ground truth, while the anchor-based method only learns deviations at previously defined locations and requires interpolation for the ground truth. Furthermore, a ground truth association is shown. In this case, a parametric representation enables an association scheme that takes all lines into account, while anchor-based methods usually use a reference point adjustment that ignores lines that do not pass through y_{ref}.

Exemplary embodiments of the present invention can have a neural network for lane detection that uses a novel parametric lane representation and novel aspects of the training scheme for learning classification and regression. The architecture of a preferred neural network is inspired by Gen-LaneNet [2]. In this sense, it uses a semantic segmentation backbone network (ERFNet [8]) in order to extract information from the provided images, in particular input images of the front view of the vehicle. While Gen-LaneNet decouples 2D segmentation from 3D geometry estimation by learning masks for lane marking and projecting them into a plan view, according to exemplary embodiments of the present invention feature maps extracted from the backbone can instead be used directly. More specifically, the last layer can be replaced such that a multi-channel feature map is obtained, which is projected onto the top view and guided through the detection head. In contrast to Gen-LaneNet, the entire architecture can be trained end-to-end. In this way, the backbone is able to learn richer feature maps for 3D estimation, and the detection head (or German: Erkennungskopf) can use the full capacity of the backbone. For example, IPM [9] can be used for the top-view transformation, as proposed in [1, 2, 3].

In this case, an important aspect of this lies in the second part of the neural network (detection head) , which uses a novel lane representation as the output. Therefore, the last layer of the detection head can provide line proposals, each containing a probability for the presence of a line, a start and end point, along with the parameters that determine the shape of the lateral (x-) and vertical (z-) components of the 3D curve that models the geometry of the line. Thus, a similar detection head as in [2] can be used, wherein the last layer, i.e. the output layer, can be of size Mx(K_{α}+K_{β}+3). Therefore, it can comprise M proposals, which can each comprise K_{α} und K_{β} parameters α and β for the x and z components. The entire output of the model can be given as {α⁽ⁱ⁾, β⁽ⁱ⁾, tₛ⁽ⁱ⁾, tₑ⁽ⁱ⁾, p⁽ⁱ⁾}ᵢ₋₁^{M}, wherein t can indicate the start and end points and p the probability of existence. The number of parameters for the x and z component K_{α} and K_{β} can further vary if different parameterizations are used for each component.

An overview of the neural network for lane detection and its parametric line representation is shown in FIG. 2. Further details on the parametric 3D representation of the lane markings are explained below.

Following previous work on 2D line detection [10, 11, 12], example embodiments of the present invention use a parametric representation in order to model lines as continuous curves.

Unlike such methods, where a single function applies to the 2D geometry in the image plane, the proposed model can describe the 3D geometry from the lane or lane markings. Consequently, the lines are shown as parameterized 3D curves. In this case, each dimension of a line l, in particular lane marking l, can be rescaled and a function fₗ₍ₜ₎ can be used to model the shape of the 3D curve in a normalized space. In general fₗ can be modeled by any kind of continuous function. A small simplification is to model only the lateral and vertical components fₗₓ₍ₜ₎ and f_{lz(t)}, since the relevant lane markings are usually roughly aligned in the direction of travel. Since fₗ mathematically describes a line of indeterminate length in 3D space, the start and end points of the lane markings must also be modeled. This can be formulated with a fixed interval t∈[tₛ, tₑ].

Polynomial functions have already been used in approaches to 2D lane detection [10, 11, 12, 13] in order to model 2D line geometry in image coordinates. However, high degrees are necessary to accurately describe even simple courses of lane markings. In contrast, B-splines [6, 7] are piecewise polynomial functions that can represent complex trajectories of lane markings due to their piecewise definition range and the independence of their basis functions. However, compared with polynomials, lower degrees are sufficient to model typical road shapes. Therefore, in embodiments of the present invention, B-splines are used to model the lateral and vertical components of the curve, as shown by way of example in FIG. 2.

An important feature of the proposed approach for 3D line recognition is the novel parametric 3D line representation and the proposed training method. In contrast to conventional methods, in which a single function for the 2D geometry in a plane is sufficient, according to exemplary embodiments of the present invention the 3D geometry can be described. Consequently, lines are represented as parameterized 3D curves in the following way:

$$l ( t ) = ( \begin{matrix}x ( t ) \\ y ( t ) \\ z ( t )\end{matrix} ) = η ⊙ {f}_{l} ( t ) = η ⊙ ( \begin{matrix}{f}_{{l}_{x}} ( t ) \\ t \\ {f}_{{l}_{z}} ( t )\end{matrix} ) , \qquad ( 1 )$$

with the normalization vector η∈R³ the continuous vector function fₗ: R→R³, the curve argument t∈[tₛ, tₑ], where tₛ, tₑ∈[0, 1] and tₛ<tₑ, and ⊙ as the element-wise product. The origin and orientation of the 3D reference frame is determined, as usual, by the camera tilt angle, which can be considered as given. Thus, the x-y plane corresponds to the projection plane of IPM in plan view. Furthermore, fₗ can be introduced, which describes the shape of 3D curves in a normalized space, and the vector of normalization constants η=[ηₓ, η_{y}, η_{z}]^{T} for rescaling the domain of each direction.

As already described above, only the lateral and vertical components fₗₓ₍ₜ₎ and f_{lz(t)} can be modeled, since the relevant lane markings are usually roughly aligned in the direction of travel. Thus, the direction of the ego movement y(t) is defined as the scaling of the curve argument t. Since fₗ describes a line of infinite length in 3D space, the start and end points of lane markings are also modeled, formulated with the fixed interval t∈[tₛ, tₑ], where η_{y}·ytₛ and η_{y}·ytₑ define the beginning and end of the lane in the y direction. B-splines are used to model the lateral and vertical components with additional offsets, such that

$${f}_{l} ( t ) = ( \begin{matrix}{\sum }_{k = 1}^{{K}_{B}} {α}_{k} \cdot {B}_{k , d} ( t ) + {α}_{0} \\ t \\ {\sum }_{k = 1}^{{K}_{B}} {β}_{k} \cdot {B}_{k , d} ( t ) + {β}_{0}\end{matrix} ) , \qquad ( 2 )$$

is obtained, where each of the K_{B} basis functions B_{(k,d)(t)} shows a piecewise polynomial of degree d and covers a certain range defined by a set of nodes {t₁, t₂, . . . , t_{K}_{_{B}}_{+1-d}}. Furthermore {αₖ, βₖ}ₖ₌₁^{K}^{_{B}} is the set of control points that indicate the effect of each basis function, i.e. controlling the shape of the curve fₗ₍ₜ₎. α₀, β₀ are additional offsets, i.e. shifts, for modeling mean shifts. With a suitable choice of the function fₗ, the proposed parametric representation allows the modeling of all kinds of 3D lane markings, which, independent of complex geometries, are monotonic in the y direction, directly from the parameters α, β.

In 3D space, lanes with different geometries can occur, such as curves to the left and right, uphill and downhill roads, or short lanes visible in the near or far range. Therefore, covering the wide variety of lanes with suitable initializations for training would lead to a large number of proposals. Assuming that most lines contain large segments that are parallel to the direction of travel of the ego vehicle, the number of proposals can be limited to a feasible set. Therefore, straight lines can be used as the initialization.

In contrast to 3D-LaneNet and Gen-LaneNet, which use a fixed reference point, according to exemplary embodiments of the present invention, the average lateral distance between the ground truth lines and the line proposals can be used as an assignment criterion. This makes it possible to assign all lane markings, even those that do not pass a specific y position. However, in typical road scenes, the first segment of most lane markings is very close to the initialization of the straight line. Therefore, instead of the average lateral distance over an entire distance, only a certain proportion of the ground truth can be taken into account. In this way, the network can benefit from suitable initializations. Furthermore, it can be

advantageous to use the so-called Hungarian method [14] for the assignment, in order to ensure an optimal assignment of ground truth lines to line proposals based on the lateral distance.

The goal of training the network on the recognition task includes, in particular, classification costs L_{c}, in order to learn the presence of lines, shape costs Lₛ, in order to minimize the distance of each line instance to the ground truth, and range costs Lᵣ, in order to learn the beginning and end of the line range. For the classification costs, the usual binary cross entropy can be used, such that one obtains

$${ℒ}_{c} ( p , \hat{p} ) = - {\sum }_{i = 1}^{M} {\hat{p}}^{( i )} log {p}^{( i )} + ( 1 - {\hat{p}}^{( i )} ) log ( 1 - {p}^{( i )} ) , \qquad ( 3 )$$

with binary ground truth \hat{p}, indicating the presence (association) of lines of ground truth. To learn line shapes, a parametric regression formulation can be provided that minimizes the L₁ distance between two 3D curves. For a predicted line instance l(t) and its corresponding ground truth \hat{l}(t), the following can be obtained:

$${ℒ}_{s} ( l , \hat{l} ) = {\int }_{{\hat{t}}_{s}}^{{\hat{t}}_{e}} {‖ w ( t ) ⊙ ( {f}_{l} ( t ) - {η}^{- 1} ⊙ \hat{l} ( t ) ) ‖}_{1} dt \qquad ( 4 )$$

$$= {\int }_{{\hat{t}}_{s}}^{{\hat{t}}_{e}} ( {w}_{x} ( t ) \cdot \vert {f}_{{l}_{x}} ( t ) - \frac{1}{{η}_{x}} \hat{x} ( t ) \vert + {w}_{z} ( t ) \cdot \vert {f}_{{l}_{z}} ( t ) - \frac{1}{{η}_{z}} \hat{z} ( t ) \vert ) dt , \qquad ( 5 )$$

where \hat{t}ₛ, \hat{t}ₑ are the beginning and the end of the ground truth lane. w(t) is a weighting function that takes into account the standard deviations of the line geometry in order to learn close range (small deviations) and far range (strong deviations) equally. In practice, the integral is approximated numerically by selecting a suitable number of ground truth points uniformly distributed along the line and calculating the pointwise distance to the associated predictions. The predicted values for x and z are obtained by t values from the ground truth

$$( \frac{\hat{y}}{{η}_{y} y} )$$

and evaluating the function components of f₍ₗ_{ₓ}₎₍ₜ₎ and f₍ₗ_{ₓ}₎₍ₜ₎ obtained. To learn the line range, a simple regression of the start and end point \hat{t}ₛ, \hat{t}ₑ of the ground truth lane can be used:

[symbol]

ᵣ(t_{s,e},\hat{t}_{s,e})=|tₛ−\hat{t}ₛ|+|tₑ−\hat{t}ₑ| (6)

Finally, the total cost function is composed of a weighted sum of classification, shape, and distance costs as follows

$$ℒ = {λ}_{c} \cdot {ℒ}_{c} ( p , \hat{p} ) + {\sum }_{i = 1}^{M} {\hat{p}}^{( i )} \cdot ( {λ}_{s} \cdot {ℒ}_{s} ( {l}^{( i )} , {\hat{l}}^{( i )} ) + {λ}_{r} \cdot {ℒ}_{r} ( {t}_{s , e}^{( i )} , {\hat{t}}_{s , e}^{( i )} ) ) . \qquad ( 7 )$$

While anchor-based approaches calculate regression costs at fixed positions regardless of the underlying line geometry, the proposed method flexibly selects the positions where costs are evaluated on the basis of the ground truth line. Consequently, in the regression, each line instance can be represented by the same number of points, i.e., parametric regression treats each line of any shape the same. On the other hand, anchor-based methods pay less attention to sharp curves and short lines that cross only a small subset of anchor positions. In addition, the calculation of costs at previously determined anchor positions is subject to systematic errors, since the values \hat{x} and \hat{z} are determined by interpolation, whereas the proposed continuous formulation allows direct evaluation of the costs using the actual ground truth (see FIG. 3).

The above description of the embodiments describes the present invention exclusively in the context of examples. Of course, individual features of the embodiments, provided they make technical sense, can be freely combined with one another without departing from the scope of the present invention.

### REFERENCES

[1] N. Garnett, R. Cohen, T. Pe'er, R. Lahav, and D. Levi, “3d-lanenet: End-to-end 3d multiple lane detection,” 2019.
[2] Y. Guo, G. Chen, P. Zhao, W. Zhang, J. Miao, J. Wang, and T. E. Choe, “Gene-lanenet: A generalized and scalable approach for 3d lane detection,” 2020.
[3] N. Efrat, M. Bluvstein, S. Oron, D. Levi, N. Garnett, and B. E. Shlomo, “3d-lanenet+: Anchor free lane detection using a semi-local representation,” arXiv/2011.01535, 2020.
[4] A. Wedel, H. Badino, C. Rabe, H. Loose, U. Franke, and D. Cremers, “B-spline modeling of road surfaces with an application to free-space estimation,” vol. 10, no. 4, pp. 572-583, 2009.
[5] L. Xiong, Z. Deng, P. Zhang, and Z. Fu, “A 3d estimation of structural road surface based on lane-line information,” IFAC Conf. on Engine and Powertrain Control, Simulation and Modeling (E-COSM), 2018.
[6] C. de Boor, “On calculating with b-splines,” Journal of Approximation Theory, vol. 6, no. 1, pp. 50-62, 1972.
[7] I. J. Schoenberg, Contributions to the Problem of Approximation of Equidistant Data by Analytic Functions, pp. 3-57. Boston, MA: Birkhäuser Boston, 1988.
[8] E. Romera, J. M. Alvarez, L. M. Bergasa, and R. Arroyo, “Erfnet: Efficient residual factorized convnet for real-time semantic segmentation,” vol. 19, no. 1, pp. 263-272, 2018.
[9] H. Mallot, H. Bülthoff, J. Little, and S. Bohrer, “Inverse perspective mapping simplifies optical flow computation and obstacle detection,” vol. 64, pp. 177-85, 1991.
[10] W. V. Gansbeke, B. D. Brabandere, D. Neven, M. Proesmans, and L. V. Gool, “End-to-end lane detection through differentiable least-squares fitting,” 2019.
[11] L. T. Torres, R. F. Berriel, T. M. Paixão, C. Badue, A. F. D. Souza, and T. Oliveira-Santos, “Polylanenet: Lane estimation via deep polynomial regression,” 2020.
[12] R. Liu, Z. Yuan, T. Liu, and Z. Xiong, “End-to-end lane shape prediction with transformers,” 2021.
[13] P. Lu, C. Cui, S. Xu, H. Peng, and F. Wang, “SUPER: A novel lane detection system,” vol. 6, no. 3, pp. 583-593, 2021.
[14] Kuhn, H. W.; “The Hungarian method for the assignment problem;” Naval Research Logistics Quarterly 2 (1-2), 83-97 (1955).

What is claimed is:

1. A method for training a model to detect lane markings, comprising the following steps:
providing images that are specific to a recording by at least one sensor of a vehicle, and in which the lane markings are mapped;
providing ground truth data specific to a geometry of the lane markings in the provided images; and
training the model based on the provided images and the provided ground truth data for a three-dimensional modeling of the geometry of the lane markings based on a parameterization of a continuous curve.

2. The method according to claim 1, wherein the model is implemented as a machine learning model that includes at least one artificial neural network with a detection head, wherein the model is trained for the three-dimensional modeling of the geometry of the lane markings in that the continuous curve is generated based on an output of the detection head of the artificial neural network for representing the three-dimensional geometry of the lane markings, wherein the continuous curve is implemented as a three-dimensional curve.

3. The method according to claim 2, wherein the three-dimensional modeling is based on the parameterization of the continuous curve by using at least one parameter of a line model to generate the continuous curve, wherein the at least one parameter is defined based on the output of the artificial neural network.

4. The method according to claim 3, wherein the model is trained to output the at least one parameter, together with a probability value for a presence of the lane markings and/or together with a start point and end point for a calculation of the curve in the modeling.

5. The method according to claim 1, wherein the model is implemented as a machine learning model that includes an artificial neural network, wherein at least two parameters are determined based on an output of the artificial neural network, wherein the parameters indicate control points of the curve in the form of a B-spline curve.

6. The method according to claim 5, wherein the images are based on the recording by the at least one sensor of the vehicle, in which the images map a lane in a direction of travel, and wherein the ground truth data specify the geometry of the lane markings on the lane by three-dimensional coordinates.

7. A method for detecting lane markings, comprising the following steps:
recording images resulting from a recording by at least one sensor of a vehicle and in which the lane markings are mapped; and
detecting the lane markings in the images by applying a model trained a three-dimensional modeling of a geometry of the lane markings based on a parameterization of a continuous curve.

8. The method according to claim 7, wherein the images are repeatedly recorded to continuously detect the lane markings in a vicinity of the vehicle during a trip, wherein the following steps are carried out:
determining lane information based on an output of the applied model;
evaluating the determined lane information by an autonomous driving function of the vehicle;
initiating a control of the vehicle based on the evaluation.

9. The method according to claim 7, wherein the model is trained by:
providing images that are specific to a recording by at least one sensor of a first vehicle, and in which the lane markings are mapped;
providing ground truth data specific to a geometry of the lane markings in the provided images; and
training the model based on the provided images and the provided ground truth data for a three-dimensional modeling of the geometry of the lane markings based on the parameterization of a continuous curve.

10. A model for detecting lane markings and for three-dimensionally modeling of a geometry of the lane markings based on a parameterization of a continuous curve, wherein the model comprises a detection head having an output layer, wherein the output layer is configured to output a plurality of parameters for detecting and generating the continuous curve, wherein the parameters include at least one of: a parameter indicating an existence and/or at least one parameter indicating the geometry.

11. The model according to claim 10, wherein the model is trained for detecting lane markings by:
providing images that are specific to a recording by at least one sensor of a vehicle, and in which the lane markings are mapped;
providing ground truth data specific to a geometry of the lane markings in the provided images; and
training the model based on the provided images and the provided ground truth data for a three-dimensional modeling of the geometry of the lane markings based on the parameterization of a continuous curve.

12. A non-transitory computer-readable medium on which is stored a computer program including instructions for training a model to detect lane markings, the instructions, when executed by a computer, causing the computer to perform the following steps:
providing images that are specific to a recording by at least one sensor of a vehicle, and in which the lane markings are mapped;
providing ground truth data specific to a geometry of the lane markings in the provided images; and
training the model based on the provided images and the provided ground truth data for a three-dimensional modeling of the geometry of the lane markings based on a parameterization of a continuous curve.

13. A device for data processing that is configured to train a model to detect lane markings, the device configured to:
provide images that are specific to a recording by at least one sensor of a vehicle, and in which the lane markings are mapped;
provide ground truth data specific to a geometry of the lane markings in the provided images; and
train the model based on the provided images and the provided ground truth data for a three-dimensional modeling of the geometry of the lane markings based on a parameterization of a continuous curve.
